(19) United States
(12) Patent Application Publication
(10) Pub. No.: US 2019/0325679 A1
(43) Pub. Date: Oct. 24, 2019

(54) GPS-Based Two-Step Authentication Engagement Mechanism

(71) Applicants: Connor Drake Rosow, Southport, CT (US); Jamie Martin Ullman, New Canaan, CT (US); Marco Joseph Volpitta, Pound Ridge, NY (US)

(72) Inventors: Connor Drake Rosow, Southport, CT (US); Jamie Martin Ullman, New Canaan, CT (US); Marco Joseph Volpitta, Pound Ridge, NY (US)

(21) Appl. No.: 16/383,646

(22) Filed: Apr. 14, 2019

Related U.S. Application Data
(60) Provisional application No. 62/660,362, filed on Apr. 20, 2018.

(51) Int. Cl. G07C 9/00; H04W 4/029

(52) U.S. Cl. CPC G07C 9/00309; G07C 9/00103; G07C 9/00119; G07C 2009/00396; H04W 4/029; G07C 2009/00603; G07C 9/00111

(57) ABSTRACT

The GPS-Based Two-Step Authentication Engagement Mechanism is intended to allow for greater security to be achieved by using it. It combines two different technologies to create a better, more secure product. The first technology is GPS technology, which allows the mechanism to find its location and use it to perform its intended actions. The second technology is a device based on technology such as RFID technology, biometric technology, alphanumerical input technology, QR code technology, barcode reading technology, combination lock technology, lock-and-key technology, gyroscope or movement device technology, light spectrum sensor technology, sound sensor technology, pressure sensor technology, touch sensor technology, and proximity sensor technology. This mechanism is different than those that came before it in that it combines functions and technology that previously didn't appear together, and provides a more secure mechanism for users than either of these technologies could provide independently.

### CROSS REFERENCES AND PRIORITIES

This application claims the benefit of U.S. Provisional Application 62/660,362 filed 20 Apr. 2018, the teachings of which are incorporated in its entirety.

### BACKGROUND

The ability for a device to know its physical location via latitude, longitude and even height relative to sea level is known.

The ability for a device to act based upon a unique identifier entered by a user, such as RFID, key cards, biometrics, physical key, punch codes or passwords is also known.

The need for mechanisms to be activated by a unique identifier only when at a specific geographic location has existed for years. For example, carrying cases, like briefcases, containing sensitive polictical documents which are to only be opened by an individual with when inside an embassy is one such need.

It remained for these inventors to develop a mechanism, such as lock, which can only be activated when at a certain pre-set location, and then by someone with the unique identifier.

### SUMMARY

The GPS-Based Two-Step Authentication Engagement Mechanism, through its two-step authentication process, strengthens the security of common single-step engagement mechanisms. The system requires the device to meet a location requirement and a secondary requirement. In the chance that one of the two steps fails, the system will prevent the mechanism from disengaging or opening. The GPS-Based Two-Step Authentication Engagement Mechanism can be applied to a variety of situations including, but not limited to, locks.

Disclosed in this specification is an article of manufacture comprising a central computing unit, connected to a power source, a location set device, an identification input device, a location device, and an engagement device.

It is further disclosed that the central computing unit is in communication with the location set device which sets a location requirement and optionally an identity requirment.

The use of an identification input device which communicates an identifier data to the central computing unit is also disclosed.

A location device used to communicate the location data of the mechanism to the central computing unit is also disclosed.

An engagment device is further disclosed with the central computing unit configured to place the engagement device in an engaged position and maintain the engagement device engaged in the engaged position until the identifier data meets the identity requirement and the location data meets the location requirement at which time the engagement device is disengaged.

It is further disclosed that the the central computing unit comprises at least a central processing unit and requisite memory components.

That the power source provides power to all components, at least two components, or at least one component of the group consisting of the central computing unit, the location set device, the identification input device, the location device and the engagment device is also disclosed.

That the location device comprises at least a Global Positioning System device capable of outputting raw geographic coordinates to the central computing unit is also disclosed. It is further disclosed that the location set device comprises at least a component capable of inputing geographic coordinates.

It is further disclosed that the identification input device comprises a component capable of providing identification selected from the group consisting of RFID technology, biometric technology, alphanumerical input technology, QR code technology, barcode reading technology, combination lock technology, lock-and-key technology, gyroscope or movement device technology, light spectrum sensor technology, sound sensor technology, pressure sensor technology, touch sensor technology, and proximity sensor technology.

That the engagement device can be selected from the group consisting of elcromagnetic solenoids, barrel locks, bolt locks, padlocks, rim locks, deadbolts, or digital locks or combinations thereof is also disclosed.

### BRIEF DESCRIPTION OF FIGURES

FIG. 1 depicts a basic electrical diagram of the engagment mechanism

FIG. 2 depicts a basic logic diagram of the mechanism using the hardware structure embodied in FIG. 1.

### DETAILED DESCRIPTION

The following is a detailed list of the elements in the Figures.

Element 100 corresponds to a central computing unit.

Element 110 corresponds to a power source.

Element 120 corresponds to a Global Positioning Unit (“GPS”).

Element 200 in this embodiment is a a numerical input device.

Element 300 in this embodiment is the identification input device.

Element 310 in this embodiment is the identifier, which in this case is the RFID Key.

Element 400 is the engagment mechanism controlled by CPU based upon the input into the GPS and identity input.

The location dependent authentication mechanism described in this specification has utility for security systems requiring access to be location dependent.

For example, it is well known that the diplomatic corps, corporate communication corp, lawyers, government agencies and the military are constantly transmitting information. Some of that information is still physically shipped or transmitted by courier in a carrying case. The diplomatic corp refers to this as the diplomatic pouch.

In the diplomatic corps, the physical item to be couried is placed into a secure case, such as a briefcase, lock box, or diplomatic pouch. The pouch is locked. In some instances the courier can open the pouch, in other cases, the courier cannot open the pouch. The pouch is to be delivered by the courier to another individual who can access the pouch and inspect the contents.

In traditional systems, there is an element of trust that the courier will not attempt to open the pouch. However, with this invention it is possible to now prevent the pouch from being accessed until the pouch reaches its destination.

The GPS-Based Two-Step Authentication Engagement Mechanism is the embodiment shown. As shown below, through its two-step authentication process, the location plus identity strengthens the security of common engagement mechanisms. By adding the physical location requirement, biometric or similar high-level devices are even further enhanced.

In the chance that one of the two steps fails, (e.g. the identifier is activated but the mechanism is not in the pre-set location or the mechanism is in the pre-set location but the identifier is improperly attempted), the mechanism maintains its engaged (locked) status and prevent the mechanism from disengaging or opening. In other words, the case cannot be opened.

In one embodiment the mechanism is a closed system, meaning that it cannot be remotely accessed any means other than the identifier and programming the location. This anti-hacking measure ensures the success of the device in the modern world of technology. The location plus identity mechanism can be applied to a variety of situations including, but not limited to, locks.

The GPS-Based Two-Step Authentication Engagement Mechanism evolved from a coding project to create a robust security solution for numerous applications. This invention has the potential to streamline security systems across a wide range of applications, as well as better protecting the assets of users as compared to current systems.

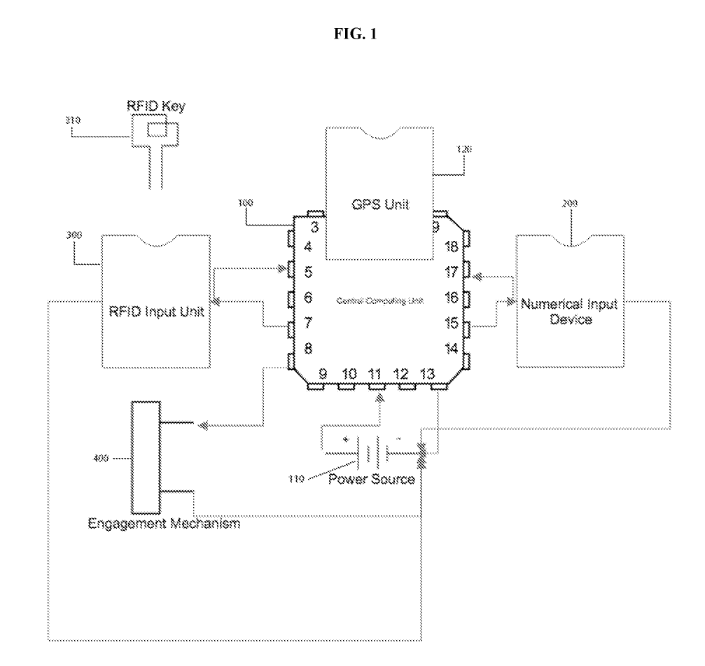

Referring to FIG. 1, the invented engagement mechanism comprises a central computing unit [100].

This central computing unit is powered by a power source [110].

The central computing unit is in communication with several data devices.

One data device is a location set device [200]. The location set device is used to set the location where the engagement device is to be disengaged. This location is called the location requirement. One embodiment of the location set device is a keyboard or key pad into which the location set data can be manually entered. Another embodiment is a wireless connection from which a separate unit could be used to enter the data. A USB or other physcial connection from a separate entry system is also envisioned. A more sophisticated system could use voice entry into the location set device.

The location set device can also optionally be used to enter an identity requirement. The identity requirement is what the identifying data entered later must meet in order for the engagement device to become disengaged.

The identity requirement could be, but is not limited to, the code corresponding to a person's fingerprint, eye scan, a series of tones, a numerical input, an QR code, a bar code, or an RFID code. Like the location requirement, identity requirement, the identity requirement is entered and stored into the engagement mechanism. The identity requirement is met when identifying data containing the identity requirement is entered into the identification input device.

The engagement mechanism will also have an identification input device [300] which communicates or transmits an identifying data to the central computing unit.

It will also have a location device [120] which communicates or transmits the location of the mechanism to the central computing unit. Generally this is accomplished by a Global Positioning Unit, (GPU), also known as a GPS. These have become common items and can readily be in communication with or integrated into a central computing unit.

The central computing unit [100] can be used to control an engagment device [400] by placing or maintaining the device in either an engaged or disengaged position.

The central computing unit is configured to place the engagement device in an engaged position and maintain the engagement device engaged in the engaged position until the identifier information meets the identity requirement [310] and the location meets the location requirement at which time the engagement device is disengaged.

The device operates according to the following steps.

A location is input into the central computing unit. Assume for example the latitude and longitude are set to correspond to the US Embassy in Russia. Assume further that the office is located on the top floor, at least 1,200 feet above sea level. This required information is entered and stored into the engagement mechanism via the location set device [200].

The location set device or other input device can also be a device configured to set the identity requirement.

The engagement mechanism maintains the engagement device engaged in an engaged position, which could be either locked or unlocked until both the identity requirement and the location requirement are met.

When it comes time to disengage the engagement mechanism identifying data will be entered into the identification device. This information will either meet the indemnification requirement or it will not. The location data from the location device will either meet the location requirement or it will not. The order of the requirement evaluation is not important. If the location requirement and identity requirement are both met the engagement device will be disengaged.

All communications can be passed over physcial connections, such as a wire or pin, or passed over wireless connections.

### WORKING EXAMPLE

A working unit was built and tested according to the design of FIG. 1.

FIG. 1 is illustrative of the embodiment using an RFID key as the identifying key containing the identifying data.

To begin, the RFID key communicates or transmits the identifying data to the RFID Input Unit, the identity input device, which is in communication with the Central Computing Unit via a physical connection in this embodiment.

The Central Computing Unit also directs a portion of the power source to the RFID Input Unit (the identity input device). The GPS Unit (location device) communicates with the Central Computing Unit via another physical connection in this embodiment, and the Central Computing Unit also directs power to the GPS Unit.

The Numerical Input Device (location set device) also operates in the same way. The Central Computing Unit also communicates with and supplies power to the Engagement Unit via a physical connection in this embodiment.

The positive portion of the Power Source is connected to the Central Computing Unit, and the ground portion is connected to the RFID Input Unit, the GPS Unit, the Numerical Input Device, the Central Computing Unit, and the Engagement Unit.

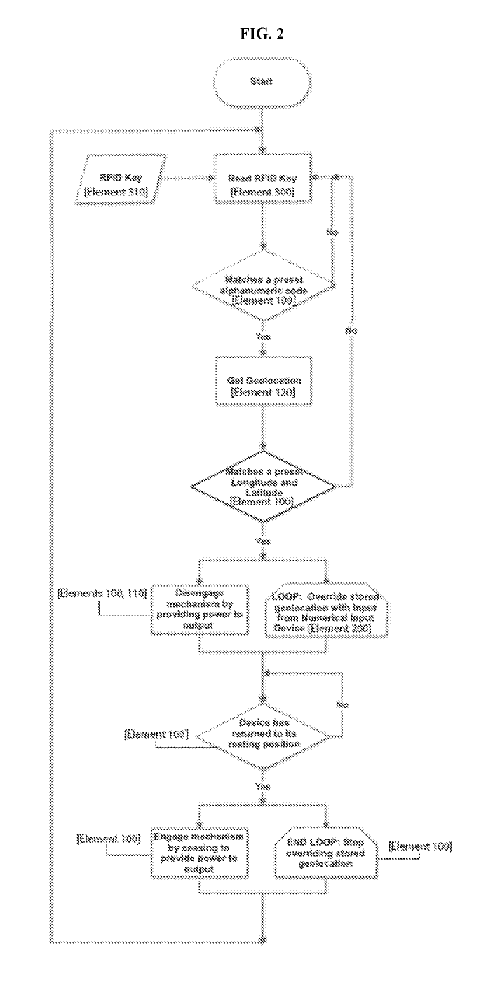

The working example was configured according to the logic of FIG. 2.

Once the mechanism is powered on, setting it to its starting state, the RFID Input Unit checks for an RFID key. If the RFID key does not contain a prespecified alphanumeric code, the mechanism cycles back to its starting state and continues checking for an RFID key.

Otherwise, if the RFID key does contain a prespecified alphanumeric, the mechanism powers the GPS Unit and reads in the geolocation. If the geolocation does not match a prespecified longitude and latitude, then the mechanism returns to its starting state and continues checking for an RFID key.

Otherwise, if the geolocation does match a prespecified longitude and latitude, the mechanism does two things simultaneously: The mechanism switches to its disengaged position by providing power to the output or the engagement device, to disengage the engagment device.

In this embodiment, there was an optional loop which repeatedly reads in a new longitude and latitude pair from the Numerical Input Device, setting the new prespecified location.

This geolocation specification loop continues while the mechanism remains disengaged as to allow the user to re-enter a geolocation as many times as needed. Once the device returns to its resting position, the mechanism simultaneously returns to its engaged position by ceasing to provide power to the output and terminates the geolocation specification loop, storing the most recent specified geolocation. Once this process is complete, the mechanism returns to its starting state and begins checking for an RFID key again.

The working example of the mechanism was constructed in the following manner:

First, an Arduino Uno R3 available from Adafruit, New York, N.Y., was used as the central computing unit. In future models, this could easily be replaced with any other suitable control unit.

The GPS unit was an GPS logger Shield available from Adafruit, New York, N.Y., which was manually connected to the top of the central unit via pins. In the future, this device could be any GPS module with the ability to communicate through a wired, soldered or wireless connection to the central unit. The GPS module could even be built directly into the central unit itself.

An antenna available from Adafruit, New York, N.Y., was wired into the GPS unit using an SMA to uFL/u.FL/IPX/IPEX RF Adapter Cable available from Adafruit. In the future, the antenna could be any form of antenna with the ability to communicate through a wired, soldered or wireless connection with the GPS unit or control unit with or without an adapter.

A USB cable available from Adafruit was used to input the code which operated according to the logic of FIG. 2 to the central computing unit.

The USB port of the central computing unit was the location input device as the longitudinal and latitudinal coordinates as well as the range of acceptable error, or the radius surrounding the coordinates, for which the system would accept the position as valid and therefore allow for the system to move to its disengaged state was entered via that USB port. In the future, this connection could be either wired, wireless, or both. In addition, this connection could be multiple connections each only updating the coordinates or uploading new instructions to the central unit.

In addition, this connection could communicate with central unit and could either allow for the system to move to its disengaged state or allow for the system to move to the state in which the system checks for a secondary security input.

The RFID receiver, the identity input device, from Adafruit, New York, N.Y., was wired into a breadboard available from Adafruit, New York, N.Y., which was then wired into the central unit. In the future, this could be any model of RFID receiver with the ability to communicate through a wired, soldered or wireless connection with the central board. The RFID unit could be replaced with any other wired or wireless security measure, such as a biometric scanner, QR code reader, barcode reader, alphanumeric or numeric input device, combination lock, classic lock-and-key lock, gyroscope or similar movement device, light spectrum sensor, sound sensor, pressure sensor, touch sensor, or a proximity sensor.

A RFID chip available from Adafruit, New York, N.Y., was used to wirelessly communicate with the RFID unit. In the future, any RFID chip could be used as long as it is compatible with RFID scanner and an RFID scanner is used.

The engagement device was a solenoid electromagnet available from Adafruit, New York, N.Y., which was wired to the central unit via the breadboard mentioned previously. In the future, this could be replaced by any locking mechanism with the ability to be controlled electronically through a wired, soldered or wireless connection. Two power supplies consisting of interconnected AA batteries were used in our working example. One power supply was wired to the central unit. The other power supply was wired to the solenoid electromagnet. In the future, these could be replaced by any single or set of power sources able to adequately support all components.

Because two power supplies were used, a Power Relay available from Adafruit, New York, N.Y., was attached to the breadboard mentioned previously and wired to the solenoid electromagnet, and central unit in order to regulate power supply. In the future, this could be an optional device and could be replaced by any single or set of power regulators to manage the flow of electricity in between any of the components, including power supplies.

While the working example used an RFID device and key to disengage the engagment device, many types of identity systems will work. Some examples follow.

Biometric technology could potentially be used as the identification input device [300], to provide security by confirming the identity of the individual attempting to disengage the mechanism. The relevant data would be stored on the central computing unit [100], and the biometric input device would be able to output the raw data entered by the individual to the central computing unit [100]. This would provide an effective alternative to the RFID technology used in the working example.

Alphanumeric input technology could potentially be used as the identification input device [300], to provide security by mandating that the individual attempting to disengage the mechanism must be in possession of a valid code. The valid code would be stored on the central computing unit [100], and the alphanumeric input device would be able to output the attempted code to the central computing unit [100]. This would provide an effective alternative to the RFID technology used in the working example

QR code technology could potentially be used as the identification input device [300], to provide security by mandating that the individual attempting to disengage the mechanism must be in possession of a valid QR code. The valid QR code would be stored on the central computing unit [100], and the QR code reader would be able to output the attempted QR code to the central computing unit [100]. This would provide an effective alternative to the RFID technology used in the working example.

Barcode technology could potentially be used as the identification input device [300], to provide security by mandating that the individual attempting to disengage the mechanism must be in possession of a valid barcode. The valid barcode would be stored on the central computing unit [100], and the barcode reader would be able to output the attempted barcode to the central computing unit [100]. This would provide an effective alternative to the RFID technology used in the working example.

Electronic combination lock technology could potentially be used as the identification input device [300], to provide security by mandating that the individual attempting to disengage the mechanism must be in possession of a valid combination. The valid combination code would be stored on the central computing unit [100], and the combination lock would be able to output the attempted combination to the central computing unit [100]. This would provide an effective alternative to the RFID technology used in the working example.

Light spectrum sensor technology could potentially be used as the identification input device [300], to provide security by verifying that the visible light within the vicinity of the mechanism matches predetermined values. The valid values would be stored on the central computing unit [100], and the sensor would be able to output the raw data to the central computing unit [100]. This would provide an effective alternative to the RFID technology used in the working example.

Sound sensor technology could potentially be used as the identification input device [300], to provide security by mandating that a correct audio signal, such as a voice message, is playing when attempting to disengage the device. The a copy of the valid audio signal would be stored on the central computing unit [100], and the sound sensor would be able to output the attempted audio to the central computing unit [100]. This would provide an effective alternative to the RFID technology used in the working example.

Pressure sensor technology could potentially be used as the identification input device [300], to provide security by mandating that the individual applies the correct amount of pressure to open the mechanism. The valid pressure value would be stored on the central computing unit [100], and the pressure sensor would be able to output the attempted pressure value to the central computing unit [100]. This would provide an effective alternative to the RFID technology used in the working example.

Touch sensor technology could potentially be used as the identification input device [300], to provide security by mandating that the individual attempting to disengage the mechanism could correctly operate the touch sensor. The valid data would be stored on the central computing unit [100], and the touch sensor would be able to output the attempted operation to the central computing unit [100]. This would provide an effective alternative to the RFID technology used in the working example.

Proximity sensor technology could potentially be used as the identification input device [300], to provide security by mandating that the individual attempting to disengage the mechanism is the correct distance from the mechanism. The valid distance would be stored on the central computing unit [100], and the sensor would be able to output the attempted distance to the central computing unit [100]. This would provide an effective alternative to the RFID technology used in the working example.

What is claimed is:

1. An article of manufacture comprising a central computing unit [100], a power source [110];
wherein the central computing unit is in communication with a location set device which sets a location requirement and optionally an identity requirment in the central computing unit,
an identification input device [300] which communicates an identifier data to the central computing unit,
a location device [120] which communicates the location data of the central computing unit to the central computing unit, and an engagment device [400];
with the central computing unit configured to place the engagement device in an engaged position and maintain the engagement device engaged in the engaged position until the identifier data meets the identity requirement [310] and the location data meets the location requirement at which time the engagement device is disengaged.

2. The article of manufacture of claim 1 wherein the central computing unit [100], comprises at least a central processing unit, requisite memory components.

3. The article of manufacture of claim 1 wherein the power source provides power to all components of the group consisting of the central computing unit, the location set device, the identification input device, the location device and the engagment device.

4. The article of manufacture of claim 1 wherein the power source provides power to at least two components of the group consisting of the central computing unit, the location set device, the identification input device, the location device and the engagment device.

5. The article of manufacture of claim 1 wherein the power source provides power to at least one component of the group consisting of the central computing unit, the location set device, the identification input device, the location device and the engagment device.

6. The article of manufacture of claim 1 wherein the location device comprises at least a Global Positioning System device capable of outputting geographic data to the central computing unit [100].

7. The article of manufacture of claim 1 wherein the location set device comprises at least a component capable of inputing geographic data.

8. The article of manufacture of claim 1 wherein the identification input device comprises a component capable of outputting identification data to the central computing unit [100] which can be selected from the group consisting of RFID technology, biometric technology, alphanumerical input technology, QR code technology, barcode reading technology, combination lock technology, lock-and-key technology, gyroscope or movement device technology, light spectrum sensor technology, sound sensor technology, pressure sensor technology, touch sensor technology, and proximity sensor technology.

9. The article of manufacture of claim 1 wherein the identitfier comprises data to be used to activate the indenitification input device [300], based upon technology which can be selected from the group consisting of RFID technology, biometric technology, alphanumerical input technology, QR code technology, barcode reading technology, combination lock technology, lock-and-key technology, gyroscope or movement device technology, light spectrum sensor technology, sound sensor technology, pressure sensor technology, touch sensor technology, and proximity sensor technology.

10. The article of manufacture of claim 1 wherein the engagement device is selected from the group consisting of elcromagnetic solenoids, barrel locks, bolt locks, padlocks, rim locks, deadbolts, or digital locks or combinations thereof.
